(19) United States
(12) Patent Application Publication
(10) Pub. No.: US 2009/0000980 A1
(43) Pub. Date: Jan. 1, 2009

(54) Have-a-heart

(76) Inventor: Jeffrey Alan Petersen, Essexville, MI (US)

Correspondence Address: JEFFREY A. PETERSEN, 1175 LEDYARD ROAD, ESSEXVILLE, MI, 48732, US

(21) Appl. No.: 12/215,737

(22) Filed: Jun. 30, 2008

Related U.S. Application Data
(60) Provisional application No. 60/937,772, filed on Jun. 30, 2007.

(51) Int. Cl. A61J 1/03; B65D 43/22; A44B 15/00

(52) U.S. Cl. 206/539; 220/315; 220/751

(57) ABSTRACT

A heart shaped container, designed to attach to your key ring. In the event of a suspected heart attack, a person places his or her thumb under the protruding tab and index finger on the top of the other tab. When pressure is applied the hinged snap on lid separates, except for the hinge, from the base. This, will make immediately accessible the suggested load of two 325 mg aspirin sitting in the pill cradles of the container base. By inverting the Have-A-Heart unit the two aspirin release into the awaiting hand, and the user then ingests one of these. The user thereby increases dramatically the chance of surviving the heart attack and greatly reduces the damage to the heart muscle. When immediate action is necessary the Have-A-Heart container will be right there on your key ring and easily distinguishable because of its red color and heart shape.

### RELATED APPLICATIONS

The present application is a continuation application of U.S. provisional patent application, Ser. No. 60/937,772, filed Jun. 30, 2007, for HAVE-A-HEART, by JEFFREY ALAN PETERSEN, included by reference herein and for which benefit of the priority date is hereby claimed.

### FIELD OF THE INVENTION

The present invention relates to preventative health care measures and, more particularly, to minimization of the negative effects of a heart attack.

### BACKGROUND OF THE INVENTION

According to the American Heart Association coronary heart disease is America's number one killer. The AHA launched a campaign quit some time ago called “Act in Time”, designed to familiarize people with heart attack warning signs and the need to take immediate action. The FDA states that ingesting one or two 325 mg of aspirin within minutes after the onset of heart attack symptoms reduces the chance of fatality by 23%. Medical sources, too numerous to mention here, recommend that when you recognize heart attack symptoms, immediately after the 911 call you should chew a 325 mg aspirin tablet (unless you are allergic to aspirin, of course). A heart attack is a blood clot inside a coronary artery normally caused by rupture in cholesterol plaques. Aggregation of platelets begins at the site and as they clump together blood flow to the heart becomes increasingly limited. Aspirin works by making the platelets less sticky and keeps the blockage at the site from growing. Health care professionals agree that time is of the essence and recommend that after calling 911 one should chew an aspirin immediately (often advised by 911 operators) and wait for EMTs to arrive.

When first I began querying people with regards to their knowledge of America's #1 killer, I was impressed with the responses I received. Everyone knows that at first recognition of heart attack symptoms one should take aspirin. The answer to my second question was not so impressive. Do you have any aspirin handy, just in case? Almost to the one, the answer was no, I don't. There is the problem. Not one of ignorance of what to do, but one of having no convenient device or mechanism that enables us to be prepared. What did all of our surveyed people have on them or at least close by in this extremely mobile society of ours? Yes, their keys. The Have-A-Heart when loaded as suggested, with two 325 mg aspirins, and attached to your key chain, also as suggested, provides the perfect solution to this problem. We hope we won't have to use the cradled aspirin in the water resistant heart shaped key chain container, but odds are many of us will. Lets be prepared to minimize the negative effects of heart attack, if not for yourself, for someone you love.

Our patent search and our search for prior art indicated to us that no other solution exists.

It would be advantageous to provide a container for quick accessibility to aspirin in the event of heart attack. Heart attacks rarely happen near your medicine cabinet. Our container, attached to your key ring, is most likely to be in your possession, or at least readily accessible to you, if this life and death event occurs.

It would also be advantageous to provide a container that limits movement of the suggested aspirin load, so as to reduce crumbling due to impact.

It would further be advantageous to provide a container that reduces the potential damage to the suggested aspirin load caused by water. This is achieved by the water resistant snap shut lid.

### SUMMARY OF THE INVENTION

In accordance with the present invention, there is provided a heart shaped container, designed to attach to your key ring. In the event of a suspected heart attack, a person places his or her thumb under the protruding tab and index finger on the top of the other tab. When pressure is applied the hinged snap on lid separates from the base. This, will make immediately accessible the suggested load of two 325 mg aspirin sitting in the pill cradles of the container base. By inverting the Have-A-Heart unit the two aspirin release into the awaiting hand, and the user then ingests one of these. The user thereby increases dramatically the chance of surviving the heart attack and greatly reduces the damage to the heart muscle. When immediate action is necessary the Have-A-Heart container will be right there on your key ring and easily distinguishable because of its red color and heart shape.

### BRIEF DESCRIPTION OF THE DRAWINGS

A complete understanding of the present invention may be obtained by reference to the accompanying drawings, when considered in conjunction with the subsequent, detailed description, in which:

FIG. 1 is an inside open view of a have-a-heart key chain container that has been opened and laid flat with both lid and base interior surfaces in view; and

FIG. 2 is an outside open view of a have-a-heart key chain container that has been opened and laid flat with both lid and base exterior surfaces exposed.

For purposes of clarity and brevity, like elements and components will bear the same designations and numbering throughout the Figures.

### DESCRIPTION OF THE PREFERRED EMBODIMENT

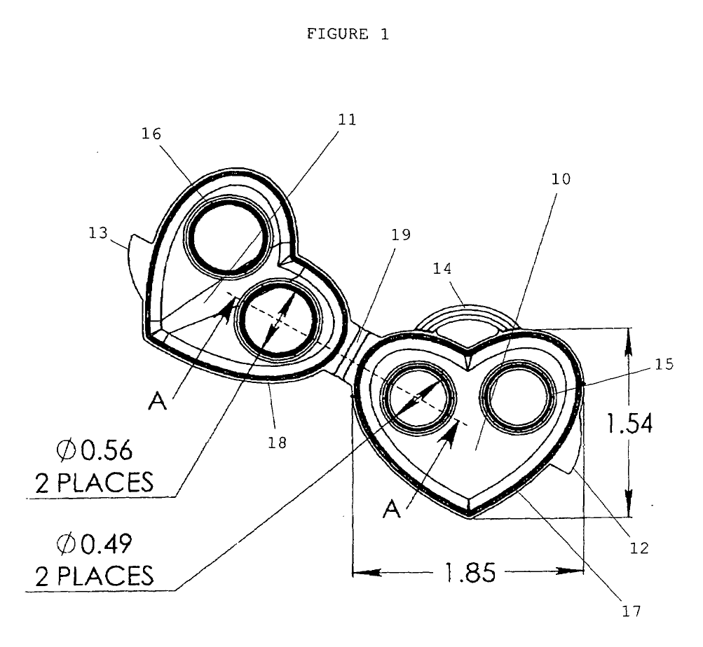

FIG. 1 is an inside open view of the Have-A-Heart key chain container that has been opened and laid flat with both the base 10 on the right side of the drawing, and lid 11, on the left side of the drawing, interior surfaces in view. Jutting from the base 10 is the protruding thumb tab 12. The material used in our prototypes of the container is profax 7624 natural dyed red, and has proven to be flexible and durable. The protruding thumb attached to the base 10 is above the protruding index finger tab 13 that is attached to the lid 11. These placements make the Have-A-Heart keychain container very easy to open despite the water and dirt resistant tight fitting snap-on lid. The key ring attachment device 14 is a continuation of the molded base, which enhances extremely, its strength and durability. The key ring attachment device 14 is large enough to allow easy attachment to the users key ring. The key ring attachment device 14 is a continuation only of the molded base, allowing the Have-A-Heart key ring container to be opened and closed without having to be removed from the users key ring. The base 10 view shows two circular upward protrusions referred to as the base load cradles 15. The inside diameter of the base load cradles 15 are slightly larger that the diameter of the suggested load of a 325 mg aspirin tablet. Inside the heart shaped lid there are also two upward protrusions referred to as the lid load cradles 16. The inside diameter of the lid load cradles 16 is slightly greater than the outside diameter of the base load cradles 15. The upward protrusion of the base load cradles 15 have a ridge at the top, allowing them to snap into the lid load cradles 16 when the container is closed. Around the circumference of the base 10 is a ridge referred to as the base perimeter lip 17. Around the circumference of the lid 11 is a ridge referred to as the lid perimeter lip 18. The base load cradles 15 and the lid load cradles 16 when snapped shut put pressure between the base perimeter lip 17 and the lid perimeter lip 18 to achieve resistance to the entry of water and dirt.

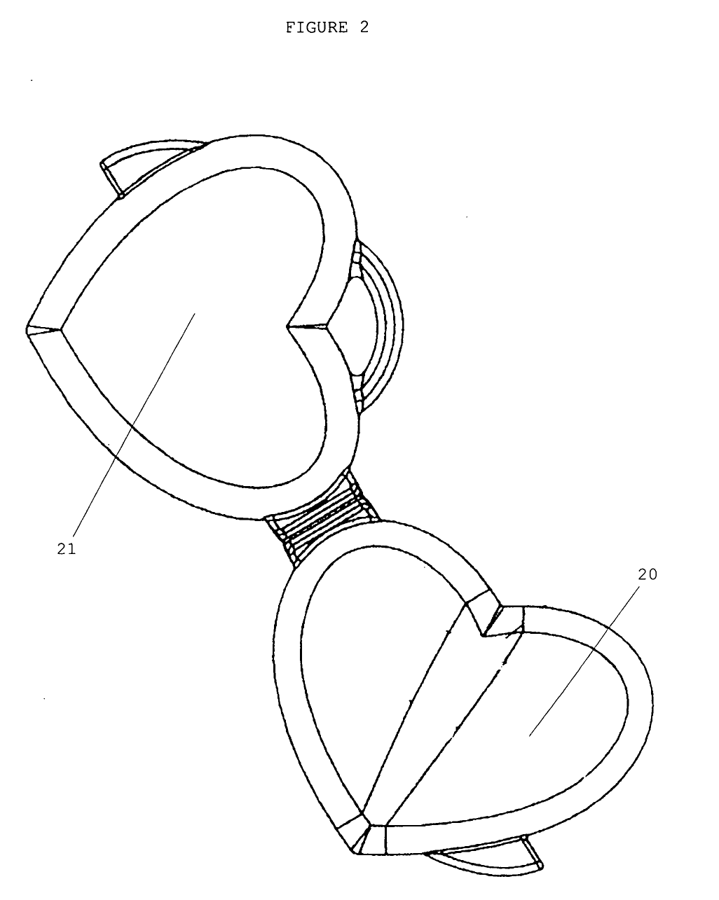

FIG. 2 is an outside open view of the Have-A-Heart key chain container that has been opened and laid flat with both the heart shaped slightly convex lid exterior 20 and flat base exterior 21 surfaces exposed. The flat base exterior 21 drawn on the lower left side of the page is connected to the heart shaped slightly convex lid exterior 20 represented on the upper right side of the drawing remain connected by a living hinge 19. The differing shapes of the flat base exterior 21 and the slightly convex lid exterior 20 allow for easy determination of which side is up when opening the Have-A-Heart container. The slightly convex lid exterior 20 is also for cosmetic purposes.

In operation the heart shape of both the base 10 and the lid 11 provide an easily recognizable shape and red color, traditionally associated with the heart, when on a key ring for quick access in an emergency. With the strength and durability of the material used, the substantial size, and the positioning, of the both the protruding thumb tab 12 and the protruding index finger tab 13, the container can be opened with ease by applying downward pressure on the protruding thumb tab 12 and upward pressure on the protruding index finger tab 13. The key ring attachment device 14 is a continuation only of the molded base, allowing the Have-A-Heart key ring container to be opened and closed without having to be removed from the users key ring. This is a time saver in a situation where time is of the essence. As mentioned above the inside diameter of the base load cradles 15 is slightly greater than the diameter of the suggested load of a 325 mg aspirin. This feature allows for a minimum amount of impact damage from the every day carrying and use of the users keys to the suggested load by virtually eliminating movement of the 325 mg aspirin when loaded in the base load cradles 15 as suggested.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A have-a-heart key chain container for facilitating the immediate availability and accessability of two 325 mg aspirin in the event of heart attack symptoms, comprising:
means for providing an easy recognition and quick access to suggested load of two 325 mg aspirin when contaner is on your key chain;
means for providing an easy to use opening mechanism requiring minimal pressure applied in opposing directions on the two protruding tabs, rigidly connected to said means for providing an easy recognition and quick access to suggested load of two 325 mg aspirin when contaner is on your key chain;
means for providing an easy to use opening mechanism requiring minimal pressure applied in opposing directions on the two protruding tabs, rigidly connected to said means for provides easy identification when on a key ring for quick access;
means for providing a secure, easy to use mechanism for attachment to the user's key ring which also allows opening and shutting of the container without removal from the key ring, rigidly connected to said means for providing an easy recognition and quick access to suggested load of two 325 mg aspirin when contaner is on your key chain;
means for maintaining the integrety of the suggested load of two 325 mg aspirin tablets;
means for keeping the lid in place and not misplaced when opening and closing the container, flexibly connected to said means for provides easy identification when on a key ring for quick access, and flexibly connected to said means for providing an easy recognition and quick access to suggested load of two 325 mg aspirin when contaner is on your key chain;
means for ease of determining which side is up when opening container.

2. The have-a-heart key chain container in accordance with claim 1, wherein said means for providing an easy recognition and quick access to suggested load of two 325 mg aspirin when contaner is on your key chain comprises a key ring attachment device that is only attached to the base so that container need not be removed from users key ring to be opened, and an easily distinguisable heart shaped, red colored base.

3. The have-a-heart key chain container in accordance with claim 1, wherein said means for providing an easy to use opening mechanism requiring minimal pressure applied in opposing directions on the two protruding tabs comprises a subtantial protrusion of 0.19 inches at its greatest point with thickness of 0.03 inches, with physical placement immediately above the protruding index finger tab, with identical dimensions, referred to as the protruding thumb tab.

4. The have-a-heart key chain container in accordance with claim 1, wherein said means for providing an easy to use opening mechanism requiring minimal pressure applied in opposing directions on the two protruding tabs comprises a substantial protrusion of 0.19 inches at its greatest point with thickness of 0.03 inches, with physical placement immedialtly below the protruding thumb tab referred to as the protruding index finger tab.

5. The have-a-heart key chain container in accordance with claim 1, wherein said means for providing a secure, easy to use mechanism for attachment to the user's key ring which also allows opening and shutting of the container without removal from the key ring comprises a continuation of the molded base strand, large enough to allow for easy slip through of key ring, which connects the key ring only to the base referred to as the key ring attachment device.

6. The have-a-heart key chain container in accordance with claim 1, wherein said means for maintaining the integrety of the suggested load of two 325 mg aspirin tablets comprises an inside diameter of the base load cradle that is very slightly greater than the diameter of the suggested load, a 325 mg aspirin tablet to minimize impact damage, the outside diameter of the base load cradle is slightly less than the inside diameter of the lid load cradle and the outside wall of the base load cradle is concave shaped and the inside wall of the lid load cradle is convex in shape to allow for the snap shut lid, the height of the base load cradle and lid load cradle walls allows for the base and lid perimeter lips, which have opposing l shaped ridges, to meet uniformly when the unit is snapped shut thereby providing a water and dirt resistant environment for suggested load placed in the base load cradles.

7. The have-a-heart key chain container in accordance with claim 1, wherein said means for keeping the lid in place and not misplaced when opening and closing the container comprises a bendable strong material, which aligns the lid load cradles with the base load cradles and gives proper placement to the lid perimeter lip in relation to the base perimeter lip when closing the lid onto the base by bending the living hinge.

8. The have-a-heart key chain container in accordance with claim 1, wherein said means for ease of determining which side is up when opening container comprises a slightly convex exterior lid attached by the living hinge to the flat base exterior.

9. A have-a-heart key chain container for facilitating the immediate availability and accessability of two 325 mg aspirin in the event of heart attack symptoms, comprising:
a key ring attachment device that is only attached to the base so that container need not be removed from users key ring to be opened, and an easily distinguisable heart shaped, red colored base, for providing an easy recognition and quick access to suggested load of two 325 mg aspirin when contaner is on your key chain;
a heart shaped, red colored lid, for provides easy identification when on a key ring for quick access;
a subtantial protrusion of 0.19 inches at its greatest point with thickness of 0.03 inches, with physical placement immediately above the protruding index finger tab, with identical dimensions, referred to as the protruding thumb tab, for providing an easy to use opening mechanism requiring minimal pressure applied in opposing directions on the two protruding tabs, rigidly connected to said base;
a substantial protrusion of 0.19 inches at its greatest point with thickness of 0.03 inches, with physical placement immedialtly below the protruding thumb tab referred to as the protruding index finger tab, for providing an easy to use opening mechanism requiring minimal pressure applied in opposing directions on the two protruding tabs, rigidly connected to said lid;
a continuation of the molded base strand, large enough to allow for easy slip through of key ring, which connects the key ring only to the base referred to as the key ring attachment device, for providing a secure, easy to use mechanism for attachment to the user's key ring which also allows opening and shutting of the container without removal from the key ring, rigidly connected to said base;
an inside diameter of the base load cradle that is very slightly greater than the diameter of the suggested load, a 325 mg aspirin tablet to minimize impact damage, the outside diameter of the base load cradle is slightly less than the inside diameter of the lid load cradle and the outside wall of the base load cradle is concave shaped and the inside wall of the lid load cradle is convex in shape to allow for the snap shut lid, the height of the base load cradle and lid load cradle walls allows for the base and lid perimeter lips, which have opposing L shaped ridges, to meet uniformly when the unit is snapped shut thereby providing a water and dirt resistant environment for suggested load placed in the base load cradles, for maintaining the integrety of the suggested load of two 325 mg aspirin tablets;
a lid load cradle diameter is slightly larger than the base load cradle, the height of the cradle walls is exactly enough to allow for the base perimeter lip and the lid perimeter lip to press tightly to one another lid load cradles, for maintaining the integrity of the suggested two 325 mg aspirin load thru its water and dirt resistant design and minimization of impact damage achieved by the perfect size of the load cradles;
an exact height of base perimeter lip achieves compression to lid perimeter lip when load cradles are snaped shut base perimeter lip, for resistence to water and dirt entering the load cradles, rigidly connected to said base;
a height of perimeter lip allows for it to meet the base perimeter lip evenly and with a degree of pressure lid perimeter lip, for achieving a water and dirt resistant container to maintain the suggested loads properties and have them ready to be ingested if needed, rigidly connected to said lid;
a bendable strong material, which aligns the lid load cradles with the base load cradles and gives proper placement to the lid perimeter lip in relation to the base perimeter lip when closing the lid onto the base by bending the living hinge, for keeping the lid in place and not misplaced when opening and closing the container, flexibly connected to said lid, and flexibly connected to said base;
an exterior of lid is slightly convex in shape slightly convex lid exterior, for cosmetic purposes; and
a slightly convex exterior lid attached by the living hinge to the flat base exterior, for ease of determining which side is up when opening container.

10. A have-a-heart key chain container for facilitating the immediate availability and accessability of two 325 mg aspirin in the event of heart attack symptoms, comprising:
a key ring attachment device that is only attached to the base so that container need not be removed from users key ring to be opened, and an easily distinguisable heart shaped, red colored base, for providing an easy recognition and quick access to suggested load of two 325 mg aspirin when contaner is on your key chain;
a heart shaped, red colored lid, for provides easy identification when on a key ring for quick access;
a subtantial protrusion of 0.19 inches at its greatest point with thickness of 0.03 inches, with physical placement immediately above the protruding index finger tab, with identical dimensions, referred to as the protruding thumb tab, for providing an easy to use opening mechanism requiring minimal pressure applied in opposing directions on the two protruding tabs, rigidly connected to said base;
a substantial protrusion of 0.19 inches at its greatest point with thickness of 0.03 inches, with physical placement immedialtly below the protruding thumb tab referred to as the protruding index finger tab, for providing an easy to use opening mechanism requiring minimal pressure applied in opposing directions on the two protruding tabs, rigidly connected to said lid;
a continuation of the molded base strand, large enough to allow for easy slip through of key ring, which connects the key ring only to the base referred to as the key ring attachment device, for providing a secure easy to use mechanism for attachment to the user's key ring which also allows opening and shutting of the container without removal from the key ring, rigidly connected to said base;
an inside diameter of the base load cradle that is very slightly greater than the diameter of the suggested load, a 325 mg aspirin tablet to minimize impact damage, the outside diameter of the base load cradle is slightly less than the inside diameter of the lid load cradle and the outside wall of the base load cradle is concave shaped and the inside wall of the lid load cradle is convex in shape to allow for the snap shut lid, the height of the base load cradle and lid load cradle walls allows for the base and lid perimeter lips, which have opposing l shaped ridges, to meet uniformly when the unit is snapped shut thereby providing a water and dirt resistant environment for suggested load placed in the base load cradles, for maintaining the integrety of the suggested load of two 325 mg aspirin tablets;
a lid load cradle diameter is slightly larger than the base load cradle, the height of the cradle walls is exactly enough to allow for the base perimeter lip and the lid perimeter lip to press tightly to one another lid load cradles, for maintaining the integrity of the suggested two 325 mg aspirin load thru its water and dirt resistant design and minimization of impact damage achieved by the perfect size of the load cradles;
an exact height of base perimeter lip achieves compression to lid perimeter lip when load cradles are snaped shut base perimeter lip, for resistence to water and dirt entering the load cradles, rigidly connected to said base;
a height of perimeter lip allows for it to meet the base perimeter lip evenly and with a degree of pressure lid perimeter lip, for achieving a water and dirt resistant container to maintain the suggested loads properties and have them ready to be ingested if needed, rigidly connected to said lid;
a bendable strong material, which aligns the lid load cradles with the base load cradles and gives proper placement to the lid perimeter lip in relation to the base perimeter lip when closing the lid onto the base by bending the living hinge, for keeping the lid in place and not misplaced when opening and closing the container, flexibly connected to said lid, and flexibly connected to said base;
a slightly convex exterior lid attached by the living hinge to the flat base exterior, for ease of determining which side is up when opening container.
